(19) United States
(12) Patent Application Publication
(10) Pub. No.: US 2004/0215544 A1
(43) Pub. Date: Oct. 28, 2004

(54) Method, system, and graphic user interface for automated asset management

(76) Inventors: Vincent Formale, Southington, CT (US); Markus Koestler, Herrenberg (DE); Jamie Randolph, Holly Springs, NC (US); Geetika Shinde, Apex, NC (US); Andree Taylor, Durham, NC (US); Gerald Tieskoetter, Raleigh, NC (US); Lagray Wells, Cary, NC (US)

Correspondence Address: Mark D. Simpson, Esquire, Synnestvedt & Lechner LLP, 2600 Aramark Tower, 1101 Market Street, Philadelphia, PA, 19107-2950, US

(21) Appl. No.: 10/083,170

(22) Filed: Feb. 26, 2002

(51) Int. Cl. G06F 17/60

(52) U.S. Cl. 705/36

(57) ABSTRACT

A business asset management system, method, and computer-program product is provided that operates in real time to allow all aspects of asset management to be performed. The present system allows users to obtain automated approval for an asset management process when they initiate the process. The method and system also ensures that assets are written off the books as soon as they have been disposed of. Further, a listing of surplus assets that can be utilized by other employees in the company is created and made available to the employees, and employees are able to transfer assets to other employees, and update assets as appropriate. In a preferred embodiment, the present invention is embodied in a Graphical User Interface (GUI).

### BACKGROUND OF THE INVENTION

1. Field of the Invention

This invention relates in general to the field of asset management systems, and more particularly to an automated web-based method, system, and Graphical User Interface for managing the inventory and disposition of property in a corporate or other large-entity environment.

2. Description of the Related Art

Large entities such as corporations purchase, maintain, and dispose of (i.e., “retire”) large amounts of business property, referred to herein as “fixed assets”. Examples of such assets include desktop computers, laptop computers, furniture, office equipment and the like.

Quite often, these assets are located at multiple locations. For example, IBM Corporation employs over 300,000 people in over 60 countries throughout the world. Even assuming that each employee at any given time possesses only a desktop computer, several pieces of office furniture, and standard office equipment (e.g., telephone, PDA, etc.), literally millions of assets around the globe must be managed.

There are numerous reasons why management of these fixed assets is important to the corporation. First, employees in one location may want to retire fixed assets that are needed by employees in another location (i.e., change the “control status” of the asset from one employee, who no longer needs the asset, to another employee who needs the asset). In addition, each department within an organization typically has its own budget, and organization-wide accounting practices typically require knowledge of fixed assets within each department and allocation of these fixed assets for depreciation, expense and tax reporting purposes, and for validation of a company's balance sheet. Thus, it is a very important organizational goal to be able to efficiently manage the inventory of fixed assets, know what and where they are, be able to easily and efficiently change their control status, and know the asset needs of the corporation.

Known systems exist for automating data concerning business property within an organization. While such systems enable active monitoring and disposition of business property, manual approval must be obtained before initiation of the automated process, which can result in numerous and lengthy delays. Further, there is nothing that assures that once the property is disposed of, an accounting is made of the disposition. In addition, such systems allow management on a periodic (non-real-time) basis only.

Accordingly, it would be desirable to have an automated system that allows users to automatically seek approval from designated employees before they can dispose of assets; that ensures that assets are written off the books once disposed; that creates a listing of surplus assets that can be utilized by other employees in the company, and that can accomplish asset management on a real-time basis.

### SUMMARY OF THE INVENTION

In accordance with the present invention, a business asset management system and method is provided that operates in real time to allow all aspects of asset management to be performed. The present system allows users to obtain automated approval for an asset management process when they initiate the process. The method and system also ensures that assets are written off the books as soon as they have been disposed of. Further, a listing of surplus assets that can be utilized by other employees in the company is created and made available to the employees, and employees are able to transfer assets to other employees, and update assets as appropriate. In a preferred embodiment, the present invention is embodied in a Graphical User Interface (GUI).

### BRIEF DESCRIPTION OF THE DRAWINGS

FIG. 1 is a block diagram of an example of a system in accordance with the operation of the present invention;

FIG. 2 is an example of a GUI screen in accordance with the present invention;

FIG. 3 is an example of a GUI screen displayed to the asset owner when the subcategory “Donation” is selected in accordance with the present invention;

FIG. 4 is an example of a GUI screen displayed to the asset owner when the “Export to” option is selected in accordance with the present invention;

FIG. 5 is an example of a GUI screen displayed in connection with the “Loss” disposal option in accordance with the present invention;

FIG. 6 is an example of a GUI screen displayed in response to selection of the “Return to WIP” option in accordance with the present invention;

FIG. 7 is an example of a GUI screen displayed when the “Sale to Employee” option is selected for a particular asset in accordance with the present invention;

FIG. 8 is an example of a GUI screen displayed when the “Sale to 3rd Party” option is selected in accordance with the present invention;

FIG. 9 is an example of a GUI screen displayed upon selection of the “Scrap” option in accordance with the present invention;

FIG. 10 is an example of a GUI displayed in connection with the selection of the “Trade In” option in accordance with the present invention; and

FIG. 11 is a flowchart illustrating the operational flow of the system in connection with use of the system to dispose of an asset.

### DETAILED DESCRIPTION OF THE PREFERRED EMBODIMENTS

The present invention combines the use of multiple databases commonly maintained by large entities, with an automated approval system, all of which are accessible by an asset “owner” via a central server accessible directly or over a network connection such as the Internet. For the purpose of this application, the term “asset owner” refers to the person or department in possession of a particular asset and responsible for its care.

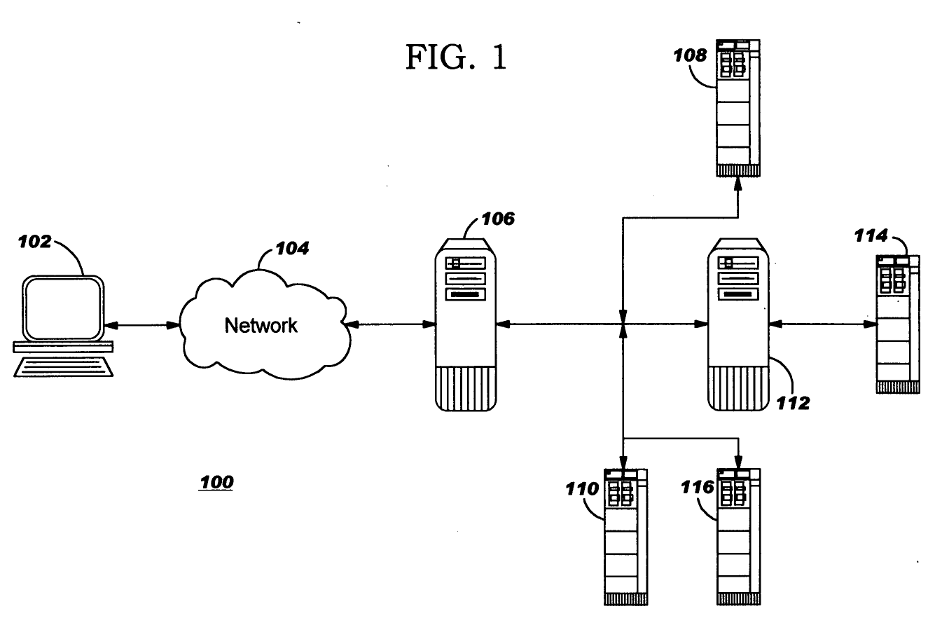

FIG. 1 is a block diagram of a system that can be used to perform the operation of the present invention. Referring to FIG. 1, a client platform 102 (e.g., a PC, web-enabled PDA, a kiosk, etc.) is coupled to a central server 106 (e.g., a web server) via a network connection 104 (e.g., a LAN, WAN, the Internet, etc.). Server 106 is coupled to a personnel database 108 (e.g., such as the IBM internal “Blue Pages” database) that gives employees access to human resources information (name, address, phone number(s), email address, work location, manager, position, etc.) regarding other employees of the company. Central server 106 is also coupled to a standard asset inventory database 110 that contains records of all fixed assets controlled by the entity, such as asset type, serial number, vendor name and model number, identity of the employee to whom the asset is assigned, etc. A known example of such an asset inventory database system is the SAP (SAP AG., Walldorf, Germany) system used by IBM and others throughout the world.

To facilitate “communications” between the central server 106, the personnel database 108, and the asset inventory database 110, central server 106 is also coupled to an automated routing system 112. The automated routing system 112 can comprise a server configured to operate automatic form processing software such as “FormWave” by IBM and is coupled to a form storage device 114 (e.g., a dedicated internal or external hard drive system) that stores forms of all kinds, including blank form templates, approved forms, disapproved forms, and the like. The form routing server facilitates, in a known manner, the generation, routing, and approval and/or disapproval of business forms via email, thus speeding up and automating the process of routing memorandum and other such forms throughout an organization.

The above-described elements are also coupled to a financial database 116 that stores financial data of the organization. This data includes tax data, balance sheets, payroll data and the like. For the present invention, the relevant financial data stored in financial database 116 includes current values (including depreciated values) of all of the fixed assets of the organization and data relating to the financial allocation of the asset values to the various departments within the organization.

The system of the present invention provides an interface, e.g., a GUI, that enables personnel within an organization to access the inventory system via any type of direct or network connection, including the organization's intranet, thereby allowing them to efficiently and effectively dispose of, transfer, update inventory information for, identify as surplus, or otherwise manage the inventory of the assets assigned to them. Since the present system links the personnel, inventory, financial, and form-routing system of the organization, the financial arm of the organization can be alerted to the status of the inventory by being included on the routing of the forms and/or being sent emails automatically identifying the changed status of the asset, and the system can be configured using known techniques to enable automatic modification of the financial records to reflect the changed status.

The system of the present invention typically operates as follows. An asset owner wishing to monitor/update/modify control over an asset logs into the system via a network such as the Internet. If desired, the organization may have in place requirements that such activity take place on a regular basis, e.g., weekly, monthly, quarterly, etc. Access to the asset management system can comprise, for example, entering a URL into a web browser to link the user to the site. Once accessing the site, the asset owner enters a user ID and password in a known manner, thereby giving the asset owner access to the site. It is understood, of course, that if the asset owner is already logged onto the company intranet for other reasons and the user ID and password is centrally administered (e.g., it is controlled by a common web authentication process), the asset owner may not need to be prompted again to enter user ID and password information upon accessing the asset management system.

Upon entering the asset management system, the personnel database 108 is accessed to provide the appropriate information for the asset owner such as his or her name, address, work location, manager, position, and the like. Based upon this information, the asset inventory database 110 is automatically accessed to obtain records of all of the fixed assets controlled by that owner. In a preferred embodiment, these assets are displayed to the asset owner on a GUI in the form of a list, with each asset in the list being “clickable”.

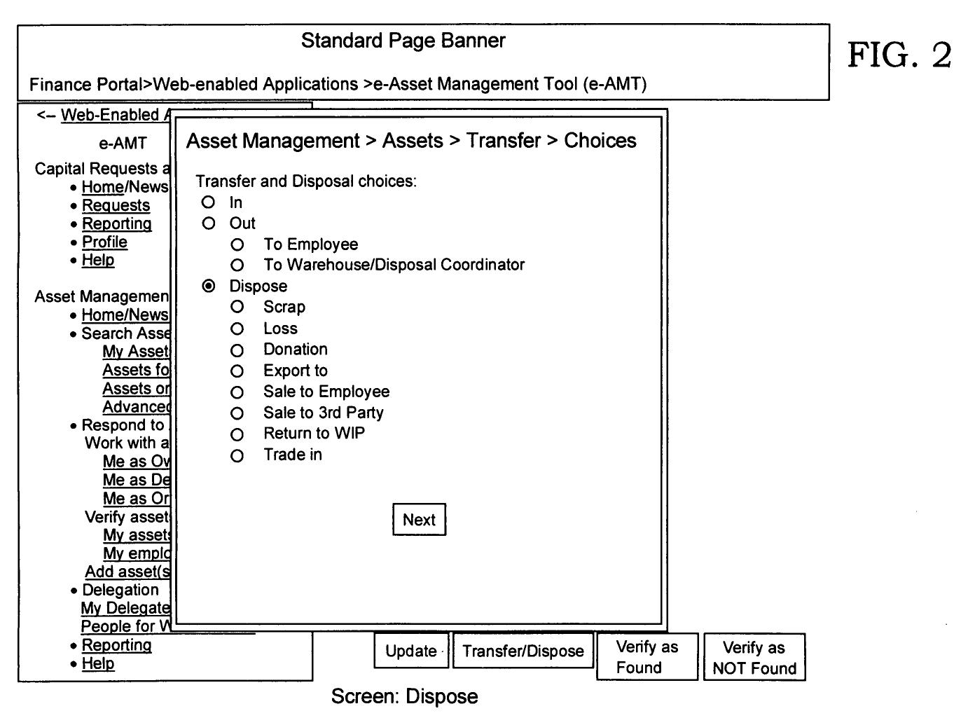

The asset owner scans through the list of assets and identifies one or more of the assets to be the subject of a status change (i.e., a “disposition”). Status changes can include, for example, transfers, updates, or disposal of the asset. FIG. 2 shows an example of a GUI screen that might be displayed to the asset owner upon selecting one or more of the assets for disposal. As can be seen in FIG. 2, the choice “Dispose” has been selected. In the example illustrated in FIG. 2, other available options include the transfer of the asset in or out of the asset owner's possession.

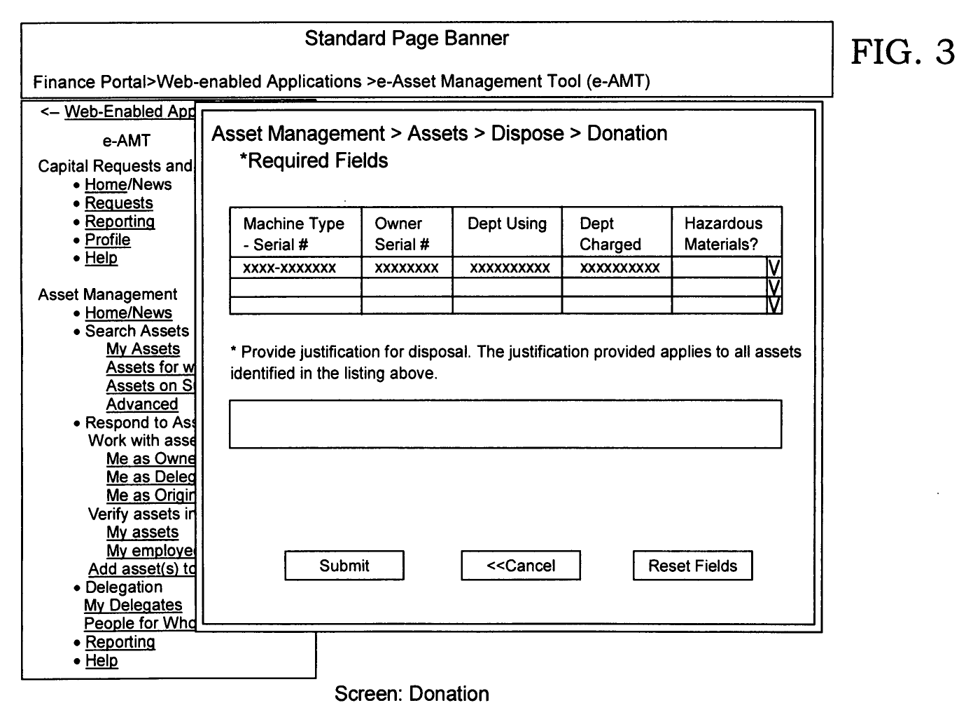

Under the category “Dispose” already selected in FIG. 2, various disposal options are given to the user, including “Scrap,” “Loss,” “Donation,” “Export to,” “Sale to Employee,” “Sale to 3rd Party,” “Return to WIP,” and “Trade in.” Obviously more or less choices may be made available to the asset owner. FIG. 3 shows an example of screen displayed to the asset owner when the subcategory “Donation” is selected. This can be displayed to the asset owner using a GUI or any other known display method. As can be seen in this example, the display to the user includes columns for “Machine Type-Serial #,” “Department Using,” “Department Charged,” and a query regarding whether or not hazardous materials are involved. In addition, a dialog box is included for providing written justification for the disposal. Obviously other information can be supplied to and/or requested from the asset owner. The asset owner then completes the uncompleted fields (e.g., identifies whether hazardous materials are included and provides the justification for disposal in the dialog box) and then submits an asset disposition request (e.g., a donation request) by clicking on the “submit” button illustrated in FIG. 3.

Once the asset disposition request is submitted, a determination is immediately and automatically made as to how many levels of approval are required. Typically, this determination is based on the value of the asset, i.e., a high-value asset might require more levels of approval than a low-value asset. The financial information regarding the value of the assets can be accessed from the financial database 116 and stored in the asset inventory database 110; the value is determined after the asset owner submits the asset disposition request. For example, the system can be set up so that for assets having a value below a predetermined threshold, no approval is required. More likely, however, and as proposed in the preferred embodiment, all action taken upon a particular fixed asset must have at least a first level of approval by the asset owner's manager and one person from the finance department. If the asset has a value above a second predetermined threshold, two levels of approval are required, e.g., the asset owner's manager and the manager's manager, in addition to a representative from the finance department. Additional approvals can be required based upon higher thresholds, if desired. The identification of who will make the approval(s) can be derived from the personnel database 108, for example, by using the managerial hierarchy identified therein.

Once the number of levels of approval are identified and, based upon information contained in the personnel database 108, who in particular will be making these approvals, the asset disposition request is submitted to the form routing server 112 so that the appropriate approval form can be generated and routed to the identified individuals. To assure that all assets being transferred and/or otherwise disposed of are appropriately recorded, all requests that are approved and executed are submitted to the financial department of the organization electronically and the financial database 116 is updated immediately and automatically to reflect the disposition of the asset (i.e., they are removed from the “books”) after completion of the asset donation or transfer. Further, if an approval results in an action to be taken by a particular individual or department (e.g., a “scrap” approval requires that the maintenance department come and remove the scrapped asset for destruction) then the final approval process also generates an email to this department to identify the asset, its location, and the disposition to be performed on the asset.

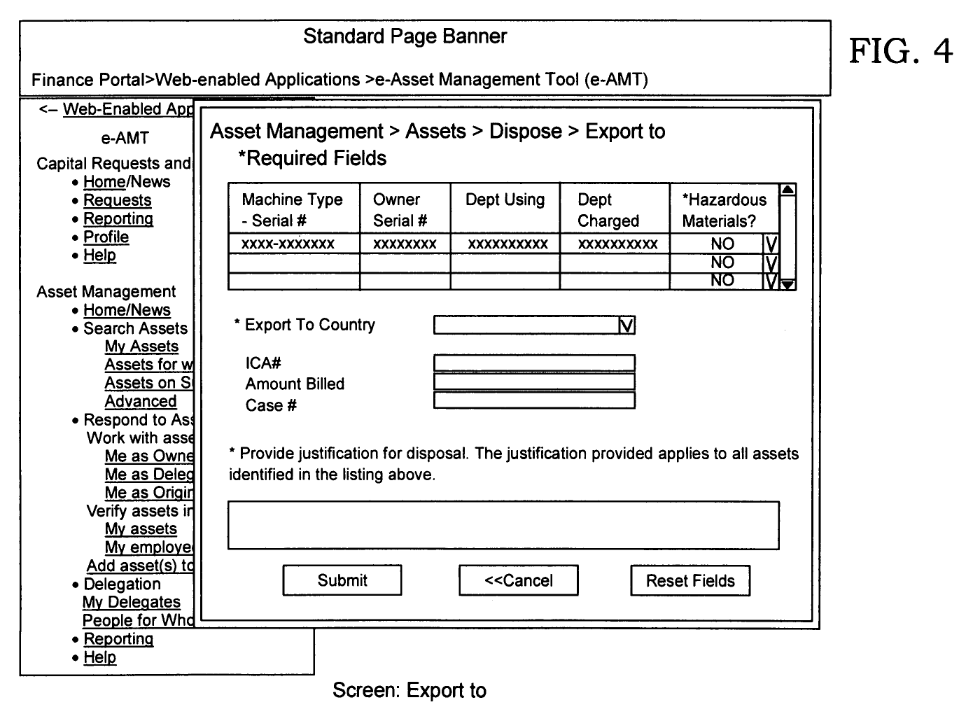

FIG. 4 illustrates an example of a GUI screen displayed to the asset owner if, instead of selecting the “Donation” option as illustrated in FIG. 3, they select the “Export to” option. Exporting of an asset may require knowledge of additional information including the country to which the asset is to be exported, an ICA (inter-company-agreement) number, the amount billed, and the case number (a number assigned to track assets). Obviously, a particular company will have different information to track, depending upon their procedures. The country needs to be identified to identify tax and legal requirements related to exporting to the selected country.

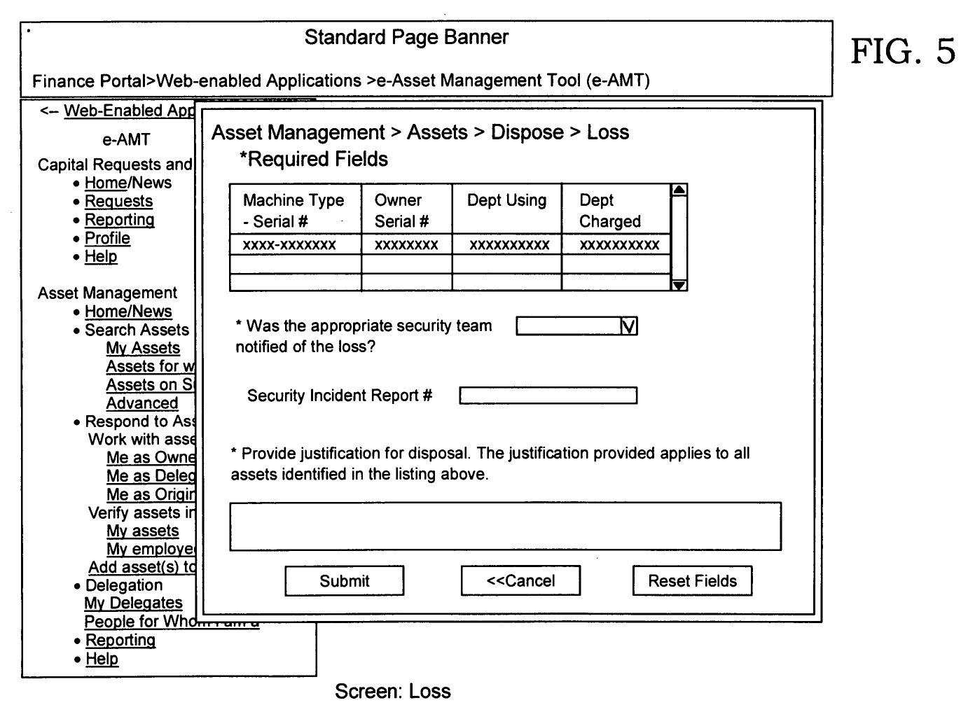

FIG. 5 illustrates a GUI screen which might be displayed in connection with the “Loss” disposal option, requiring the asset owner to indicate whether or not a security team or other security organization within the company has been notified of the loss and provide a security incident report number so that the loss can be tracked, insurance coverage can be sought, etc.

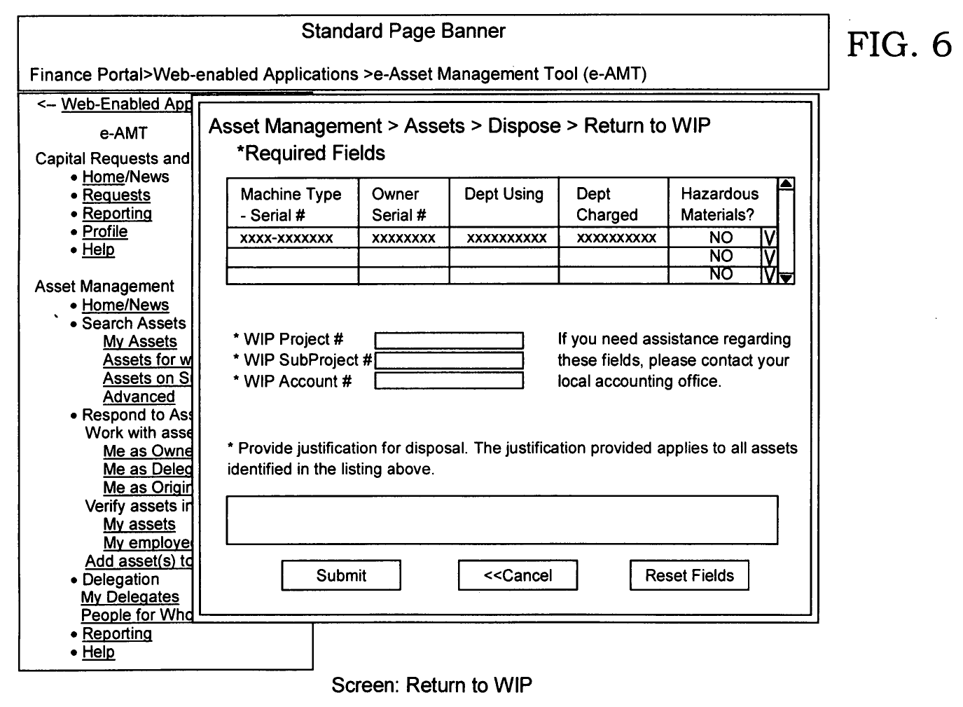

FIG. 6 illustrates a GUI screen which might be displayed in response to selection of the “Return to WIP” option. WIP refers to “work in process” and is a common category in an organization for an asset which is in the process of being built or readied for use. For example, a visually impaired employee might require a desktop PC having a text-to-speech system installed thereon. Typically the PC will be a standard PC which is ordered by the organization and not initially assigned to any particular individual as an owned asset. The PC will then be modified within the organization to have the text-to-speech software and hardware installed and tested prior to delivery of the asset, now fully operational, to the employee. For assets that are in this “limbo” state, they frequently will be assigned to “WIP” while they are being prepared. Likewise, if a particular asset was built for a particular project, once the project is completed, the asset might be “returned to WIP” to be reconfigured for a new project.

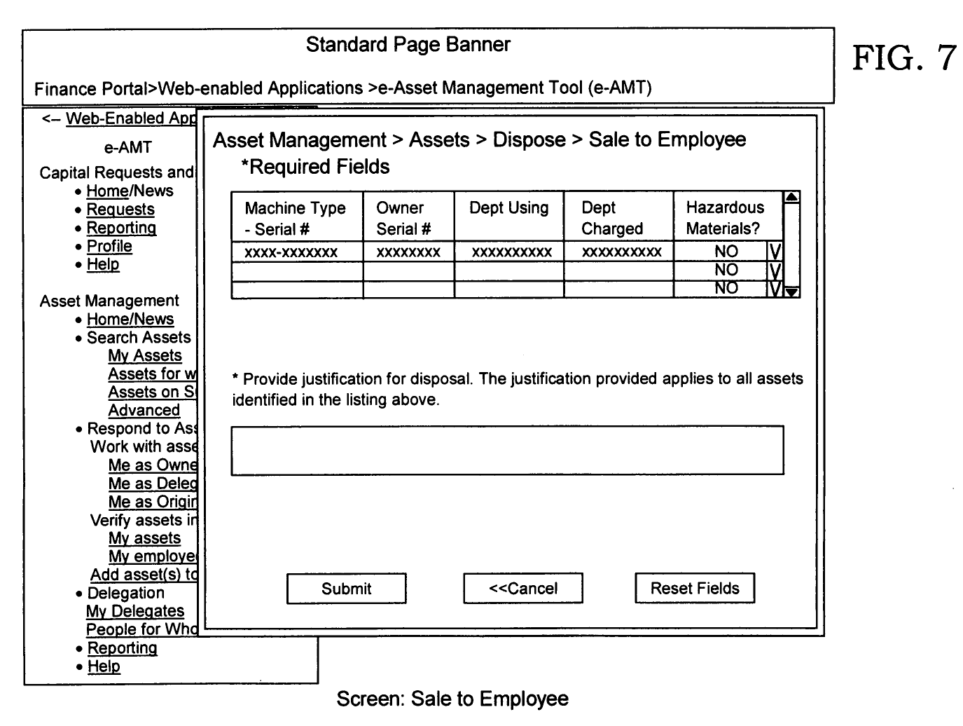

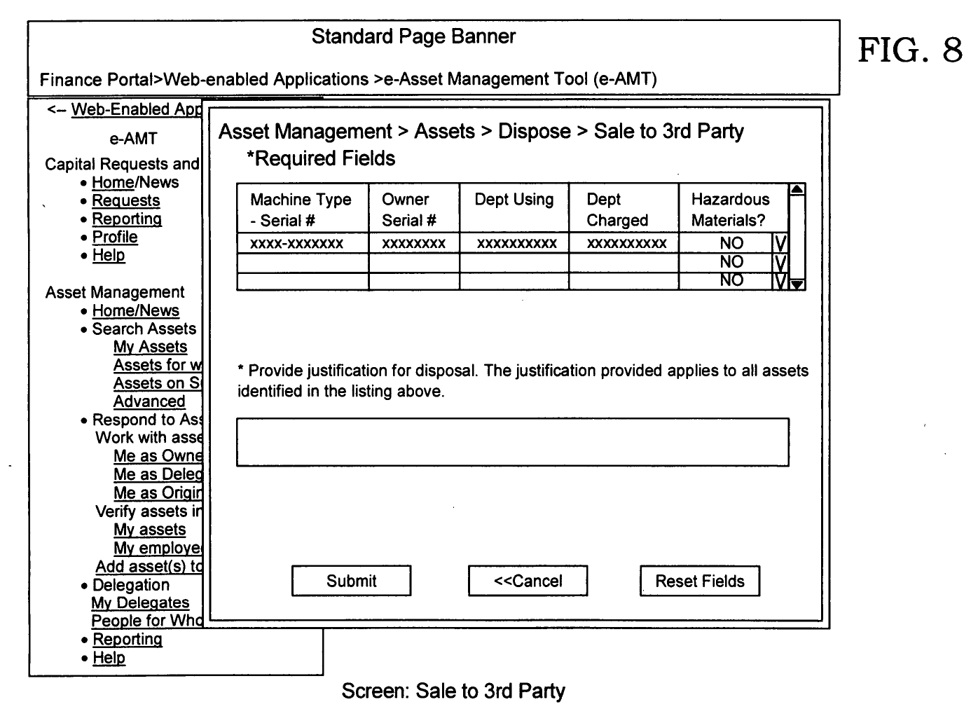

FIG. 7 illustrates a GUI screen which might be displayed when the “Sale to Employee” option is selected for a particular asset, and FIG. 8 illustrates a GUI screen that might be displayed when the “sale to 3rd Party” option is selected. The information provided by the asset owner for these types of disposition is essentially the same, thus, the GUI screens are essentially identical.

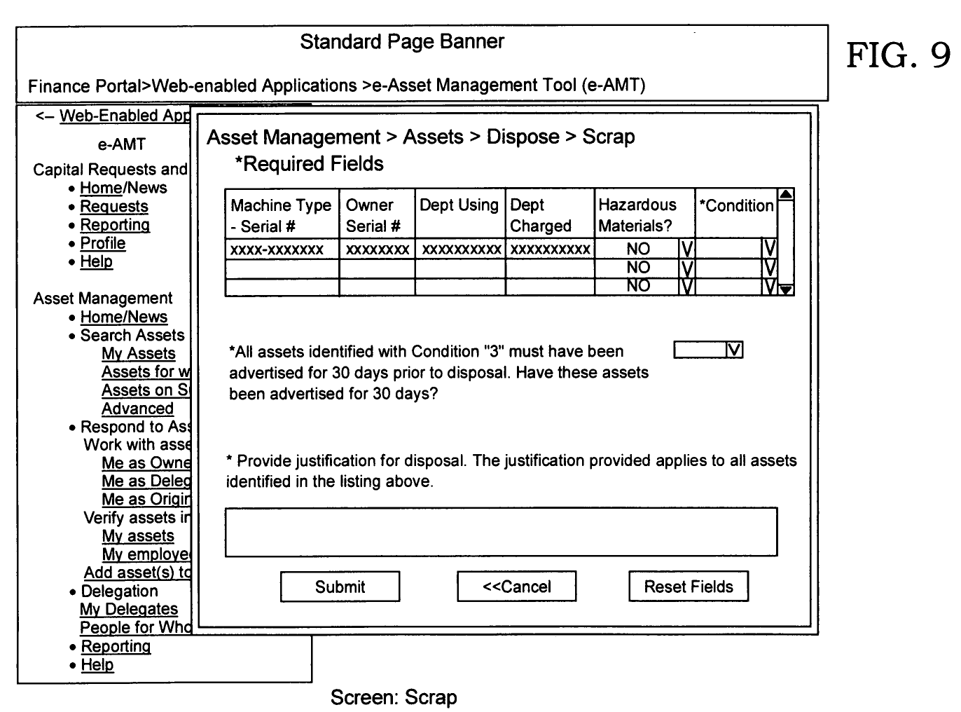

FIG. 9 illustrates a GUI screen which might be displayed upon selection of the “Scrap” option. As can be seen in FIG. 9, the hazardous material option by default is “No” (since most assets do not contain hazardous materials, such as batteries, fluids, etc.) and a column is provided to identify the condition of the asset. Further, based upon the condition identified in the condition column, the user may be required to confirm that the asset has been advertised for 30 days prior to disposal. This is part of the surplus process. If the asset is still in useable condition, someone else in the company may be able to use it. Accordingly, prior to disposal, the asset owner can be directed to designate the asset as “surplus” for 30 days (or any desired time period). This makes the asset available to other employees; for example, employees could click on a “surplus” link to be linked to a list of all surplus items.

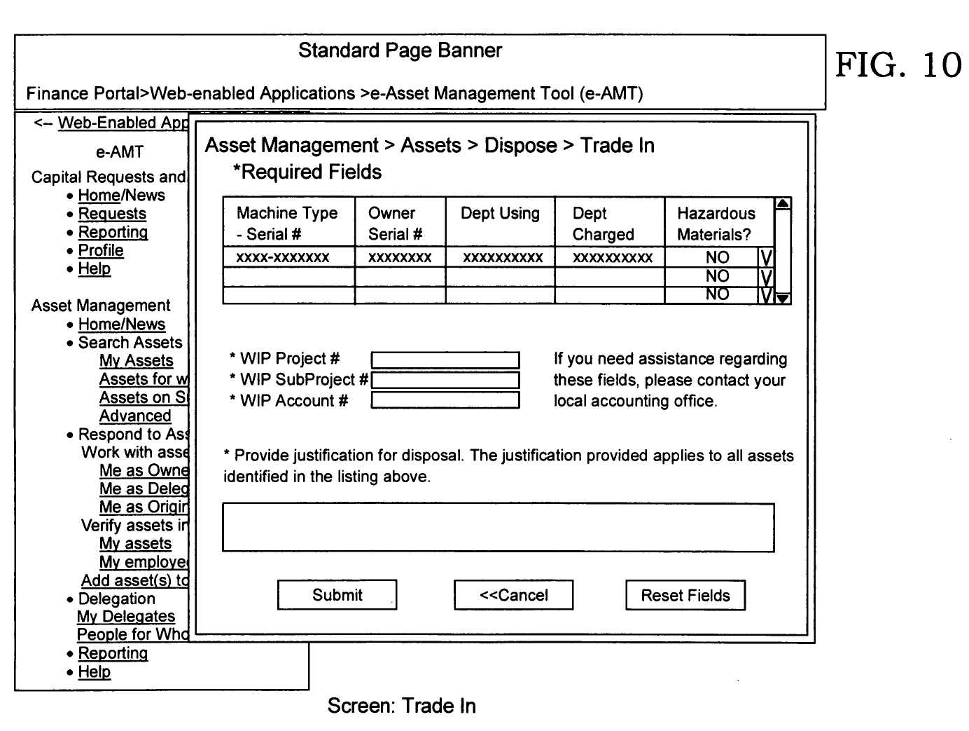

FIG. 10 illustrates an example of a GUI which might be displayed in connection with the selection of the “Trade In” option. This allows employees to look at available assets and see if he/she has an asset to trade in for an available asset, e.g., to upgrade a computer.

As will be appreciated, the specific GUI screens and/or the information solicited from the screens (or in the non-web context, the information solicited) can vary widely depending on the needs of the user; any manner of soliciting the needed information and enabling it to be used to accomplish the purpose of the GUI screens illustrated in FIGS. 2-10 will suffice.

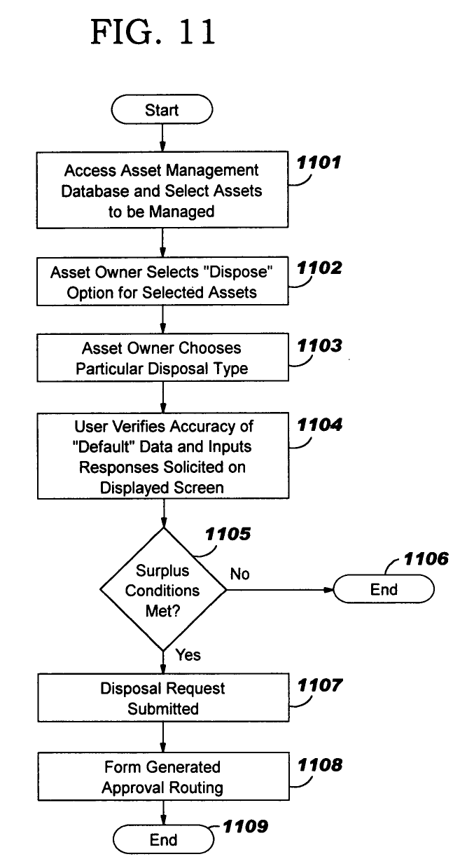

FIG. 11 is a flowchart illustrating the operational flow of the system in connection with use of the system to dispose of an asset. At step 1101, the asset owner doing the asset maintenance, having already logged on and been given access to the system, selects the asset(s) to be disposed of. If desired, the system can be configured in a well-known manner so that multiple assets may be selected simultaneously. Further, the system can be configured so that all of the selected assets are automatically subjected to the same treatment with a single designation (e.g., by selecting the “Donation” selection box, all of the selected assets are scheduled for donation) or it can be configured so that each of the selected assets can be designated individually for treatment (e.g., a first asset can be selected for donation, a second for sale to a 3^{rd} party, a third scrapped, a fourth transferred, etc.).

Since the example illustrated in FIG. 11 is of a disposal of an asset, at step 1102, the user selects the “Dispose” option and at step 1103 chooses a disposal type (e.g., “Scrap”. At step 1104, the user can verify that the “default” information automatically input for the asset is accurate (e.g., confirm the accuracy of the serial no, model no., etc.) and, if needed, change the information so that it is correct. The asset owner also inputs the responses solicited (e.g., inputs the justification for the disposal and any other requested information such as information pertaining to hazardous materials).

At step 1105, a determination is made as to whether or not all of the surplus conditions have been met. For example, if the company policy is to place all assets in surplus before disposal, then at step 1105 a determination is made as to whether or not this has been done. If all of the surplus conditions have not been met, the process ends (step 1106) and the item cannot be disposed of at this time, and the asset must be listed as surplus before disposal. However, if at step 1105 all surplus conditions are determined to have been met, at step 1107 the asset owner is given clearance to submit the disposal request (e.g., by selecting the “submit” button). At step 1108, the data is passed to the form generating system for approval routing and appropriate forms are generated for the approval routing. If all of the approvals are obtained, the persons needed to effect the disposal are notified, and the finance department is advised so that the asset can be removed from the books of the asset owner (automatically or manually) and either “retired” or assigned to its new owner within the organization, and then the process ends (step 1109).

As discussed above, in a preferred embodiment, the present invention is embodied in a GUI. GUIs typically include windows, buttons, and other graphical elements, in contrast to the text-only interfaces that preceded them. A graphical user interface may alternatively be referred to as an object-oriented user interface, reflecting the fact that the user of this type of interface interacts with objects, which are visibly displayed in a graphical representation. Users of this type of interface typically interact with the underlying software application(s) and moving a pointing cursor over an object using, for example, a mouse or similar pointing device, such as a light pen, and then indicating (for example, by clicking a mouse button or pressing a light pen) that the object should be selected. Alternatively, a touch-sensitive display screen can be used. In that situation the user interacts with the software application by touching the object he or she wishes to select.

As is well known, a programmer writing a software application having an object-oriented user interface defines the physical layout of the graphical objects on the user interface screen, as well as the functioning of the objects and any logical relationships among those objects. The function represented by an object can be as simple as setting the value of a variable used by the software application, or it can represent a more complex function, such as initiating the execution of a software subroutine, program, or any other function desired by the programmer.

All of the properties of object-oriented programming, as well as related oriented object programming techniques, are well known to those skilled in the art, and will not be discussed in depth herein. From the description recited herein, a skilled programmer could implement the present invention.

Although the present invention has been described with respect to a specific preferred embodiment thereof, various changes and modifications may be suggested to one skilled in the art and it is intended that the present invention encompass such changes and 101 modifications as fall within the scope of the appended claims.

We claim:

1. A method of managing assets controlled by members of an organization, said organization having a central server configured to access data and software systems of said organization, comprising the steps of:
identifying one or more of said assets for management and submitting an asset disposition request to said central server;
automatically, based on receipt of said asset disposition request, obtaining all required approvals for said asset disposition request;
automatically, based on said obtaining of all required approvals, effecting said asset disposition request; and
automatically modifying said data to reflect said effected disposition request.

2. A method as set forth in claim 1, wherein said step of automatically modifying said data comprises modifying financial data of said organization.

3. A method as set forth in claim 2, wherein said financial data comprises at least tax records and balance sheets.

4. A method as set forth in claim 1, wherein said data includes asset inventory data, personnel data, and financial data, and wherein said software systems of said organization include an automated routing system coupled to said asset inventory data, said personnel data, and said financial data, said step of automatically obtaining all required approvals comprising at least the steps of:
identifying from said asset inventory data all assets affected by said asset disposition request;
determining from if said identified assets meet a predetermined disposition criteria;
if said predetermined disposition criteria has been met, identifying from said personnel data any personnel required to approve said asset disposition request;
requesting approvals from said identified personnel using said automated routing system; and
receiving said approvals from said identified personnel using said automated routing system.

5. A method as set forth in claim 4, wherein said step of automatically effecting said asset disposition request comprises at least the steps of:
changing the control status of identified assets in accordance with said asset disposition request;
notifying, using said automated routing system, any member of said organization responsible for effecting said disposition request;
receiving, from said member(s) of said organization responsible for effecting said disposition request, confirmation that said asset disposition request has been effected; and
notifying, using said automated routing system, all members of said organization affected by said disposition.

6. A method as set forth in claim 5, wherein said disposition comprises transferring said identified asset(s) from one member to another member of said organization.

7. A method as set forth in claim 5, wherein said disposition comprises selling said identified asset(s) to a third party outside of said organization.

8. A method as set forth in claim 5, wherein said disposition comprises transferring said identified asset(s) from one department to another department within said organization.

9. A method as set forth in claim 5, wherein said disposition comprises retiring said identified asset(s).

10. A method as set forth in claim 5, wherein said disposition comprises placing said identified asset(s) in a list of surplus assets for a predetermined period of time.

11. A system for managing assets controlled by members of an organization, said organization having a central server configured to access data and software systems of said organization, comprising:
means for identifying one or more of said assets for management and submitting an asset disposition request to said central server;
means for automatically, based on receipt of said asset disposition request, obtaining all required approvals for said asset disposition request;
means for automatically, based on said obtaining of all required approvals, effecting said asset disposition request; and
means for automatically modifying said data to reflect said effected disposition request.

12. A system as set forth in claim 11, wherein said means for automatically modifying said data modifies financial data of said organization.

13. A system as set forth in claim 12, wherein said financial data comprises at least tax records and balance sheets.

14. A system as set forth in claim 11, wherein said data includes asset inventory data, personnel data, and financial data, and wherein said software systems of said organization include an automated routing system coupled to said asset inventory data, said personnel data, and said financial data, said means for automatically obtaining all required approvals comprising at least:
means for identifying from said asset inventory data all assets affected by said asset disposition request;
means for determining if said identified asset(s) meet a predetermined disposition criteria;
means for identifying from said personnel data, if said predetermined disposition criteria has been met, any personnel required to approve said asset disposition request;
means for requesting approvals from said identified personnel using said automated routing system; and
means for receiving said approvals from said identified personnel using said automated routing system.

15. A system as set forth in claim 14, wherein said means for automatically effecting said asset disposition request comprises at least:
means for changing the control status of identified assets in accordance with said asset disposition request;
means for notifying any member of said organization responsible for effecting said disposition request;
means for receiving, from said member(s) of said organization responsible for effecting said disposition request, confirmation that said asset disposition request has been effected; and
means for notifying all members of said organization affected by said disposition.

16. A system as set forth in claim 15, wherein said disposition comprises transferring said identified asset(s) from one member to another member of said organization.

17. A system as set forth in claim 15, wherein said disposition comprises selling said identified asset(s) to a third party outside of said organization.

18. A system as set forth in claim 15, wherein said disposition comprises transferring said identified asset(s) from one department to another department within said organization.

19. A system as set forth in claim 15, wherein said disposition comprises retiring said identified asset(s).

20. A system as set forth in claim 15, wherein said disposition comprises placing said identified asset(s) in a list of surplus assets for a predetermined period of time.

21. A computer program product for managing assets controlled by members of an organization, said organization having a central server configured to access data and software systems of said organization, the computer program product comprising a computer-readable storage medium having computer-readable program code embodied in the medium, the computer-readable program code comprising:
computer-readable program code that identifies one or more of said assets for management and submits an asset disposition request to said central server;
computer-readable program code that automatically, based on receipt of said asset disposition request, obtains all required approvals for said asset disposition request;
computer-readable program code that automatically, based on said obtaining of all required approvals, effects said asset disposition request; and
computer-readable program code that automatically modifies said data to reflect said effected disposition request.

22. A computer program product as set forth in claim 21, wherein the computer-readable program code that automatically modifies said data comprises computer-readable program code that modifies financial data of said organization.

23. A computer program product as set forth in claim 22, wherein said financial data comprises at least tax records and balance sheets.

24. A computer program product as set forth in claim 21, wherein said data includes asset inventory data, personnel data, and financial data, and wherein said software systems of said organization include an automated routing system coupled to said asset inventory data, said personnel data, and said financial data, and wherein the computer-readable program code that automatically obtains all required approvals comprises at least:
computer-readable program code that identifies from said asset inventory data all assets affected by said asset disposition request;
computer-readable program code that determines if said identified assets meet a predetermined disposition criteria;
computer-readable program code that, if said predetermined disposition criteria has been met, identifies from said personnel data any personnel required to approve said asset disposition request;
computer-readable program code that requests approvals from said identified personnel using said automated routing system; and
computer-readable program code that receives said approvals from said identified personnel using said automated routing system.

25. A computer program product as set forth in claim 24, wherein the computer-readable program code that automatically effects said asset disposition request comprises at least:
computer-readable program code that changes the control status of identified assets in accordance with said asset disposition request;
computer-readable program code that notifies, using said automated routing system, any member of said organization responsible for effecting said disposition request;
computer-readable program code that receives, from said member(s) of said organization responsible for effecting said disposition request, confirmation that said asset disposition request has been effected; and
computer-readable program code that notifies, using said automated routing system, all members of said organization affected by said disposition.

26. A computer program product as set forth in claim 25, wherein said disposition comprises transferring said identified asset(s) from one member to another member of said organization.

27. A computer program product as set forth in claim 25, wherein said disposition comprises selling said identified asset(s) to a third party outside of said organization.

28. A computer program product as set forth in claim 25, wherein said disposition comprises transferring said identified asset(s) from one department to another department within said organization.

29. A computer program product as set forth in claim 25, wherein said disposition comprises retiring said identified asset(s).

30. A computer program product as set forth in claim 25, wherein said disposition comprises placing said identified asset(s) in a list of surplus assets for a predetermined period of time.
